(19) United States
(12) Patent Application Publication
(10) Pub. No.: US 2010/0253888 A1
(43) Pub. Date: Oct. 7, 2010

(54) Colored composition, color filter and method of manufacturing the same

(75) Inventors: Hideyo Tanaka, Tokyo (JP); Isao Shigemori, Tokyo (JP); Yusuke Iida, Tokyo (JP); Mari Iwasaki, Tokyo (JP); Kenro Sunahara, Tokyo (JP); Morihide Miyamura, Tokyo (JP); Takeshi Ikeda, Tokyo (JP); Eishi Aoki, Tokyo (JP); Genki Harada, Tokyo (JP); Azumi Sato, Tokyo (JP)

Correspondence Address: STAAS & HALSEY LLP, SUITE 700, 1201 NEW YORK AVENUE, N.W., WASHINGTON, DC, 20005, US

(73) Assignee: TOPPAN PRINTING CO., LTD., Tokyo (JP)

(21) Appl. No.: 12/801,636

(22) Filed: Jun. 17, 2010

Related U.S. Application Data
(63) Continuation of application No. PCT/JP2008/072865, filed on Dec. 16, 2008.

(30) Foreign Application Priority Data
Dec. 19, 2007 (JP) 2007-327827
Dec. 19, 2007 (JP) 2007-327847

(51) Int. Cl. G02F 1/1335; C08J 3/28; B05D 3/06

(52) U.S. Cl. 349/106; 522/65; 522/39; 427/554

(57) ABSTRACT

Disclosed is a coloring composition including a pigment, a transparent resin, a monomer having an ethylenic unsaturated double bond, and a photo-polymerization initiator, wherein a ratio (M/P) of weight (M) of the monomer having an ethylenic unsaturated double bond to weight (P) of the transparent resin is confined to a range of 0.12 to 1.35, and the coloring composition is adapted to be employed in a manufacturing method of a color filter including coating a surface of a substrate with the coloring composition, irradiating a filter segment-forming region or a black matrix-forming region of the coated coloring composition film with a laser beam having a wavelength of 340 nm to 380 nm, thereby curing the irradiated region, and removing uncured portion of the coated coloring composition film to form the filter segment or the black matrix.

### CROSS REFERENCE TO RELATED APPLICATIONS

This is a Continuation Application of PCT Application No. PCT/JP2008/072865, filed Dec. 16, 2008, which was published under PCT Article 21(2) in Japanese.

This application is based upon and claims the benefit of priority from prior Japanese Patent Applications No. 2007-327827, filed Dec. 19, 2007; and No. 2007-327847, filed Dec. 19, 2007, the entire contents of both of which are incorporated herein by reference.

### BACKGROUND OF THE INVENTION

1. Field of the Invention

The present invention relates to a coloring composition for a color filter to be employed in a color liquid crystal display device, a color image pickup device, etc., to a manufacturing method of a color filter using the coloring composition, and to a color filter to be manufactured by the manufacturing method.

2. Description of the Related Art

A color filter constituting a liquid crystal display (LCD) is constructed such that two or more kinds of fine stripe-like filter segments differing in hue from each other are arranged in parallel or in an intersected manner with each other on the surface of a transparent substrate such as a glass substrate, or constructed such that two or more kinds of filter segments differing in hue from each other are arranged longitudinally and laterally to form constant arrays on the surface of a transparent substrate. These filter segments are respectively as small as several microns to several hundred microns and are regularly arranged, thereby forming a predetermined individual array for each hue.

The filter segments, i.e., a black matrix constituting the color filter, can be created by a process wherein a photosensitive material is coated on a substrate, such as a glass substrate, to form a photosensitive layer and, after the excess portion of a solvent has been removed from the layer through the drying thereof, an active energy beam is irradiated to the layer by the application of proximity exposure (ultraviolet source exposure) through a photomask designed for forming pixels, thereby curing the layer (negative type) or increasing the alkali-solubility of the layer (positive type) to create easily dissoluble portions, which are subsequently selectively dissolved by making use of an alkaline solution, etc., thus forming the filter segments, i.e., the black matrix. This process is repeated for each color, i.e. red, green and blue, for example, thereby manufacturing a color filter.

In recent years, color liquid crystal display devices are widely employed in liquid crystal color televisions, in car navigation systems, and in liquid crystal display device-integrated notebook-sized personal computers, thus creating a large market. Further, by taking advantage of the characteristics of the color liquid crystal display device, such as reductions in energy and space requirements, liquid crystal display devices are now propagated in the form of monitors for desktop personal computers, and televisions. Although the liquid crystal display device is now attracting much attention as an alternative to the conventional CRT (cathode ray tube television) display device, the color reproducibility of the liquid crystal display device is inferior to that of the CRT. Therefore, a color filter having an arrangement of a prescribed number of colors is now increasingly demanded in order to improve the color reproducibility thereof.

Further, it has been generally practiced to interpose a black matrix between the filter segments constituting each of the colors of the color filter in order to improve the color contrast. However, in terms of overcoming environmental problems, lowering the reflection of the black matrix and reducing the manufacturing cost, the employment of a resinous black matrix comprising a light-shielding pigment dispersed in a resin is now being focused on as an alternative to the conventional metallic chrome black matrix. This resinous black matrix, however, is accompanied with a problem that the light-shielding property (optical concentration) thereof is lower than that of the metallic chrome black matrix.

In order to improve the color reproducibility of the color filter and also to improve the light-shielding property of the black matrix, it is necessary to increase the content of the pigment in a photosensitive coloring composition or increase the thickness of the film. However, in the case of increasing the content of the pigment, various problems are brought about, such as the lowering of sensitivity, the deterioration of the developing property, and the deterioration of the resolving property in a patterning process by means of photolithography. Whereas, in the case of increasing the film thickness, it may become difficult for the exposure light to reach the bottom portion of the film, raising various problems such as the deterioration in pattern configuration, etc.

In order to overcome these problems, it is required to enhance the sensitivity of the photosensitive coloring composition, as suggested in JP-A 2003-156842, wherein (1) the attachment of a reactive double bond to a resin; (2) the selection or content increase of a photo-polymerization initiator or of a photosensitizer; and (3) the selection or content increase of a monomer are disclosed.

However, taking only the measures such as the attachment of a reactive double bond to a resin, and the selection of a photo-polymerization initiator, a photosensitizer and a monomer will be limited in their effects to improve the sensitivity of the photosensitive coloring composition. Especially, when the content of the photo-polymerization initiator is increased, it will give rise to coloration due to a color peculiar to the photo-polymerization initiator, deterioration of heat resistance, decrease of light transmittance and decrease of resolving power. On the other hand, when the content of the monomer is increased, it will give rise to the problem of tackiness, etc.

On the other hand, due to a trend in recent years to further increase the size of products utilizing a color filter, the size of the photomask for forming the filter segment and the black matrix is also inevitably required to be made larger, thereby leading to an increase in manufacturing cost.

In the case of the proximity exposure method (ultraviolet source exposure method) which has been generally employed, in order to enable a large substrate to be processed, a photomask which is expensive and large in size so as to match the size of the substrate is required to be employed. However, in the case of the laser exposure method, it is possible to miniaturize a photomask or to dispense with the employment of a photomask, thus making it possible to expect a reduction in cost.

In Japanese Patent No. 3912405, there are disclosed studies on a curable composition wherein a semiconductor laser having an operating wavelength of 405 nm is employed as an exposure light source. However, this patent publication fails to disclose sufficient studies on a coloring composition which is well matched with the laser having an operating wavelength of 340-380 nm. Namely, according to this patent publication, when the conventional coloring composition was employed and a laser having an operating wavelength of 340-380 nm was employed for the exposure thereof, it was impossible to obtain, at a high sensitivity, a pattern excellent in configuration. Further, when the content of a dyestuff in a coloring composition was increased or the film thickness was increased in order to improve the color reproducibility of the color filter and to enhance the light-shielding properties of the black matrix, it was found more difficult to obtain a pattern excellent in configuration.

Further, in the case of the laser exposure method in general, when the exposure of a color coated film formed of a coloring composition is carried out by means of a laser, the surface of the color coated film is more easily cured as compared with the interior of the coated film, thus generating a difference in degree of curing in the coated film. As a result, there have been raised various problems, depending on the degree of this difference in curing, such as surface peeling of the coated film, surface wrinkling of the coated film, and deterioration of adhesion of the coated film to a substrate, especially in the case of a black matrix.

Herein, the term “surface peeling” means a phenomenon in which only the surface portion of the coated film which is cured at first is peeled therefrom on the occasion of developing the color coated film. Further, the term “surface wrinkling” means a phenomenon in which, in the process of shrinking the coated film on the occasion of baking after development of the color coated film, corrugation, or wrinkling is generated on the surface of the coated film due to a difference in degree of the aforementioned curing.

The generation of these problems becomes more prominent in the cases where the content of a dyestuff in a coloring composition is increased or the film thickness is increased in order to improve the color reproducibility of the color filter and to enhance the light-shielding properties of the black matrix in compliance with the demands in recent years.

Meanwhile, in JP-A 2003-156617, there are disclosed studies on a method of irradiating the rear side of a substrate with an active energy beam for the purpose of enhancing the adhesion of the coated film to the substrate of the black matrix. However, the system of exposure disclosed therein does not use a laser, and the enhancement of adhesion of the coated film to the substrate is directed to only the adhesion of the black matrix.

Further, in JP-A 11-174221, there is disclosed a method of manufacturing a color filter wherein the process of forming each of color coated films comprises a step of a first exposure, wherein each color coated film is irradiated with ultraviolet rays from the surface thereof to create a pattern in each of the color coated films prior to the development thereof; and a step of a second exposure wherein each color coated film is again irradiated with ultraviolet rays after the development and before the baking of each color coated film. With respect to the exposure of the color coated film from an ultraviolet ray source in the step of the second exposure, this publication states that the exposure may be performed onto the front surface of each color coated film, onto the rear surface of each color coated film through a transparent substrate, or onto both front and rear surfaces of each color coated film.

### BRIEF SUMMARY OF THE INVENTION

It is an object of the present invention to provide a coloring composition which is not only high in sensitivity even if the content of dyestuff is increased or the film thickness is increased as it is exposed by way of a laser exposure system using a specific wavelength, but also capable of forming filter segments and a black matrix, which are excellent in pattern configuration, free from the generation of surface peeling of coated film and surface wrinkling and excellent in adhesion thereof to a substrate. Objects of the present invention are to provide a method of manufacturing a color filter by making use of such a coloring composition and to provide a color filter to be manufactured by such a manufacturing method.

According to a first aspect of the present invention, there is provided a coloring composition comprising: a pigment; a transparent resin; a monomer having an ethylenic unsaturated double bond; and a photo-polymerization initiator, wherein a ratio (M/P) of weight (M) of the monomer having an ethylenic unsaturated double bond to weight (P) of the transparent resin is confined to a range of 0.12 to 1.35, and the coloring composition is adapted to be employed in a manufacturing method of a color filter including: coating a surface of a substrate with the coloring composition; irradiating a filter segment-forming region or a black matrix-forming region of the coated coloring composition film with a laser beam having a wavelength of 340 nm to 380 nm, thereby curing the irradiated region; and removing uncured portion of the coated coloring composition film to form the filter segment or the black matrix.

According to a second aspect of the present invention, there is provided a method of manufacturing a color filter, which comprises: coating a substrate with the coloring composition of the first aspect to form a color coated film; irradiating a filter segment-forming region or a black matrix-forming region of the color coated film with a laser beam having a wavelength of 340-380 nm, thereby curing the irradiated region; and removing uncured portions of the color coated film to form the filter segment or the black matrix.

According to a third aspect of the present invention, there is provided a color filter comprising a black matrix and/or filter segments exhibiting at least one color, which are formed through the method of the second aspect.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DETAILED DESCRIPTION OF THE INVENTION

Next, the coloring compositions according to embodiments of the present invention will be explained.

The coloring composition according to a first embodiment of the present invention is featured in that it comprises a pigment, a transparent resin, a monomer having an ethylenic unsaturated double bond, and a photo-polymerization initiator, wherein the ratio (M/P) of the weight (M) of the monomer having an ethylenic unsaturated double bond to the weight (P) of the transparent resin is confined to the range of 0.12-1.35, the coloring composition being adapted to be employed in a manufacturing method of a color filter, which comprises: forming a color coated film on a surface of a substrate by making use of the coloring composition; irradiating a filter segment-forming region or a black matrix-forming region of the color coated film with a laser beam having a wavelength of 340 nm-380 nm, thereby curing the irradiated region; and removing uncured portions of the color coated film to form the filter segment or the black matrix.

Due to the employment of the aforementioned coloring composition, it is now possible to miniaturize the photomask or to dispense with the employment of a photomask and to realize a coloring composition which is not only high in sensitivity even if the content of dyestuff is increased or the film thickness is increased as it is exposed by way of a laser exposure system, which makes it possible to expect a reduction in cost, but also capable of forming filter segments and a black matrix which are excellent in pattern configuration.

Next, each of the components constituting the aforementioned coloring composition will be explained.

(Pigments)

With respect to the pigment to be contained in the coloring composition according to the first embodiment of the present invention, it is possible to employ organic pigments which are generally available in the market. Depending on the hue of the filter segment desired to be formed, it is possible to co-use dyes, natural pigments or inorganic pigments.

As for the organic pigments, it is preferable to employ those which are high in color-developing property and also excellent in heat resistance and thermal decomposition resistance. The organic pigment can be employed singly or in combination of two or more kinds thereof.

Further, the organic pigment may be one which is finely-ground by means of salt milling, acid pasting, etc.

Following are specific examples of the organic pigment that can be used in the coloring composition according to the first embodiment of the present invention, these organic pigments being respectively represented by a color index (C.I.) number.

For the formation of the red filter segment by making use of the coloring composition according to the first embodiment of the present invention, it is possible to employ red pigments such as C.I. Pigment Red 7, 9, 14, 41, 48:1, 48:2, 48:3, 48:4, 81:1, 81:2, 81:3, 122, 123, 146, 149, 168, 177, 178, 184, 185, 187, 192, 200, 202, 208, 210, 216, 220, 223, 224, 226, 240, 254, 255, 264, 272, etc. This red coloring composition may be employed together with a yellow pigment or an orange pigment.

For the formation of the green filter segment by making use of the coloring composition according to the first embodiment of the present invention, it is possible to employ green pigments such as C.I. Pigment Green 7, 10, 36, 37, 58, etc. This green coloring composition may be employed together with a yellow pigment.

For the formation of the blue filter segment by making use of the coloring composition according to the first embodiment of the present invention, it is possible to employ blue pigments such as C.I. Pigment Blue 15, 15:1, 15:2, 15:3, 15:4, 15:6, 16, 64, 80, etc. Further, this blue coloring composition may be used together with a violet pigment.

For the formation of the yellow filter segment by making use of the coloring composition according to the first embodiment of the present invention, it is possible to employ C.I. Pigment Yellow 1, 2, 3, 4, 5, 6, 10, 12, 13, 14, 15, 16, 17, 18, 24, 31, 32, 34, 35, 35:1, 36, 36:1, 37, 37:1, 40, 42, 43, 53, 55, 60, 61, 62, 63, 65, 73, 74, 77, 81, 83, 93, 94, 95, 97, 98, 100, 101, 104, 106, 108, 109, 110, 113, 114, 115, 116, 117, 118, 119, 120, 123, 126, 127, 128, 129, 138, 139, 147, 150, 151, 152, 153, 154, 155, 156, 161, 162, 164, 166, 167, 168, 169, 170, 171, 172, 173, 174, 175, 176, 177, 179, 180, 181, 182, 185, 187, 188, 193, 194, 198, 199, 213, 214, etc.

For the formation of the violet filter segment by making use of the coloring composition according to the first embodiment of the present invention, it is possible to employ C.I. Pigment Violet 1, 19, 23, 27, 29, 30, 32, 37, 40, 42, 50, etc.

For the formation of the magenta filter segment by making use of the coloring composition according to the first embodiment of the present invention, it is possible to employ pigments such as C.I. Pigment Red 7, 14, 41, 48:1, 48:2, 48:3, 48:4, 81:1, 81:2, 81:3, 146, 168, 177, 178, 184, 185, 187, 200, 202, 208, 210, 246, 254, 255, 264, 270, 272, etc. Incidentally, this magenta coloring composition may be employed together with a yellow pigment.

For the formation of the cyan color filter segment by making use of the coloring composition according to the first embodiment of the present invention, it is possible to employ pigments such as C.I. Pigment Blue 15:1, 15:2, 15:3, 15:4, 15:6, 16, 80, etc.

For the formation of the orange color filter segment by making use of the coloring composition according to the first embodiment of the present invention, it is possible to employ C.I. Pigment Orange 36, 43, 51, 55, 59, 61, 71, 73, etc.

For the formation of the black matrix by making use of the coloring composition according to the first embodiment of the present invention, it is possible to employ carbon black, aniline black, anthraquinone-based black pigment, perylene-based black pigment. Specific examples of these pigments includes C.I. Pigment Black 1, 6, 7, 12, 20, 31, etc. This black coloring composition may be used as a mixture thereof with a red pigment, a blue pigment or a green pigment. As for specific examples of the black pigment, it is preferable to employ carbon black in terms of price and light-shielding property. This carbon black may be surface-treated with a resin. Further, in order to regulate the color tone, the black coloring composition may be used together with a blue pigment or a violet pigment.

In the case of the coloring composition according to the first embodiment of the present invention, the concentration of the pigment components in all of nonvolatile matters is preferably confined, in view of securing a sufficient color reproducibility, to 10-90% by weight, more preferably 15-85% by weight, most preferably 20-80% by weight. When the concentration of the pigment components is lower than 10% by weight, it may become difficult to sufficiently secure the color reproducibility. When the concentration of the pigment components is higher than 90% by weight, the concentration of the pigment carrier in the coloring composition becomes too low, so that the stability of the coloring composition may be more likely to be deteriorated.

In order to secure excellent coating properties, and sensitivity and developing properties of a coloring composition while making it possible to retain a balance between the chroma and lightness, the coloring composition may contain an inorganic pigment. As for specific examples of the inorganic pigment, they include titanium oxide, barium sulfate, zinc white, lead sulfate, yellow lead, zinc yellow, red iron oxide (red iron oxide (III)), cadmium red, ultramarine blue, Prussian blue, chromium oxide green, cobalt green, amber, titanium black, synthesized iron black, carbon black, etc. These inorganic pigments may be used singly or in combination of two or more kinds thereof. These inorganic pigments may be used at a ratio of 0.1-10% by weight based on a total weight (100% by weight) of pigments.

Further, for the purpose of toning, the coloring composition according to the first embodiment of the present invention may further contain dyes within a limit which does not deteriorate the heat resistance of the color filter. Dyes may be used at a ratio of 0.1-10% by weight based on a total weight (100% by weight) of pigments.

(Transparent Resins)

The transparent resin to be contained in the coloring composition preferably has a permeability of not less than 80%, more preferably not less than 95% in a total wavelength range of 400-700 nm of the visible light zone. As for specific examples of the transparent resin, it is possible to employ thermoplastic resin, thermosetting resin and photosensitive resin. These resins can be employed singly or in combination of two or more kinds thereof.

As for the thermoplastic resin, it is possible to employ, for example, butyral resin, styrene-maleic acid copolymer, chlorinated polyethylene, chlorinated polypropylene, polyvinyl chloride, vinyl chloride-vinyl acetate copolymer, polyvinyl acetate, polyurethane resin, polyester resin, acrylic resin, alkyd resin, polystyrene, polyamide resin, rubber type resin, cyclized rubber-based resin, celluloses, polybutadien, polyethylene, polypropylene, polyimide, etc.

As for the thermosetting resin, it is possible to employ, for example, epoxy resin, benzoguanamine resin, rosin-modified maleic resin, rosin-modified fumaric acid resin, phenol resin, melamine resin, urea resin, etc.

As for the photosensitive resin, it is possible to employ a resin having an ethylenic unsaturated double bond, such as a resin which is constituted by a polymer having a reactive substituent group such as a hydroxyl group, carboxyl group, amino group, etc., into which a functional group having an ethylenic unsaturated double bond such as a (metha)acryloyl group, styryl group, etc. has been introduced through a reaction between the polymer and a (metha)acrylic compound or cinnamic acid, each having a reactive substituent group such as isocyanate group, aldehyde group, epoxy group, etc. Specific examples of such a resin include those that can be obtained through a reaction between a copolymer obtained through the copolymerization of an ethylenic unsaturated monomer having a hydroxyl group with other kinds of ethylenic unsaturated monomer and a compound having an ethylenic unsaturated double bond and a functional group which is reactive with a hydroxyl group. As for the functional group which is reactive with the hydroxyl group, it includes an isocyanate group, carboxyl group, etc. However, an isocyanate group is preferable especially in terms of reactivity. Specific examples of the compound having isocyanate group and an ethylenic unsaturated double bond include 2-acryloylethyl isocyanate, 2-methacryloylethyl isocyanate, etc. It is also possible to employ a polymer containing an acid anhydride such as a styrene-maleic anhydride copolymer or α-olefin-maleic anhydride copolymer and half-esterified with a (metha)acrylic compound having a hydroxyl group such as hydroxyalkyl (metha)acrylate, etc.

(Monomers having an Ethylenic Unsaturated Double Bond)

A monomer having an ethylenic unsaturated double bond and useful herein is a component that can be cured through the irradiation of an excimer laser beam having a wavelength of 340 nm-380 nm.

As for specific examples of the monomer having an ethylenic unsaturated double bond, they include various kinds of acrylic esters and methacrylic esters such as 2-hydroxyethyl(metha)acrylate, 2-hydroxypropyl(metha)acrylate, cyclohexyl(metha)acrylate, polyethyleneglycol di(metha)acrylate, pentaerythritol tri(metha)acrylate, pentaerythritol tetra(metha)acrylate, trimethylolpropane tri(metha)acrylate, dipentaerythritol penta(metha)acrylate, dipentaerythritol hexa(metha)acrylate, caprolactone-modified dipentaerythritol hexa(metha)acrylate, tricyclodecanyl (metha)acrylate, melamine (metha)acrylate, epoxy(metha)acrylate, etc.; reaction products between a (metha)acrylate compound having a hydroxyl group such as dipentaerythritol penta(metha)acrylate and a diisocyanate compound such as hexamethylene diisocyanate, etc.; reaction products between a (metha)acrylate compound having hydroxyl group such as dipentaerythritol penta(metha)acrylate and a glycol-based compound such as ethylene glycol, etc.; (metha)acrylic acid; styrene; vinyl acetate; (metha)acryl amide; N-hydroxymethyl (metha)acryl amide; acrylonitrile; etc. In viewpoint of increasing the sensitivity of the coloring composition, the monomer preferably has 4-12 ethylenic unsaturated double bonds, more preferably 6-12 ethylenic unsaturated double bonds. The monomer having ethylenic unsaturated double bonds may be used singly or in combination of two or more kinds thereof.

The content of the monomer having ethylenic unsaturated double bonds is preferably confined to 10-300 parts by weight based on 100 parts by weight of the pigment. When the content of the monomer is less than 10 parts by weight, it may become impossible to sufficiently secure the sensitivity of the composition even if a laser having an operating wavelength of 340-380 nm is employed, thereby necessitating the increase of exposure energy (intensity and time) for compensating the insufficiency of sensitivity, thus inviting the possibility of generation of roughened pixels. On the other hand, when the content of the monomer is larger than 300 parts by weight, the sensitivity of the composition may become too strong when a laser having an operating wavelength of 340-380 nm is employed, thereby deteriorating the linearity of pixels or deteriorating the cross-sectional configuration of pixels. More preferably, the content of the monomer may be confined to 10-200 parts by weight based on 100 parts by weight of the pigment.

Further, the ratio (M/P) of the weight (M) of the monomer having ethylenic unsaturated double bonds to the weight (P) of the transparent resin is preferably confined to the range of 0.12-1.35. When this M/P is smaller than 0.12, it may become impossible to sufficiently secure the sensitivity of the composition even if a laser having a wavelength of 340-380 nm is employed, thereby increasing the possibility of peel-off of pixels and necessitating the increase of exposure energy (intensity and time) for compensating the insufficiency of sensitivity, thus inviting a cause for the generation of roughened pixels. More preferably, the ratio M/P may be not less than 0.20, most preferably not less than 0.30. On the other hand, when this M/P is larger than 1.35, the sensitivity of the composition may become too strong as a laser having an operating wavelength of 340-380 nm is employed, thereby deteriorating the cross-sectional configuration of pixels. More preferably, the ratio

M/P may be not more than 1.25, most preferably not more than 1.15.

(Photo-polymerization Initiator)

With respect to the photo-polymerization initiator, it is possible to employ an acetophenone-based photo-polymerization initiator such as 4-phenoxy dichloroacetophenone, 4-t-butyl-dichloroacetophenone, diethoxyacetophenone, 1-(4-isopropylphenyl)-2-hydroxy-2-methylpropan-1-one, 1-hydroxycyclohexylphenyl ketone, 2-methyl-1-[4-(methylthio)phenyl]-2-morpholinopropan-1-one, 2-benzyl-2-dimethylamino-1-(4-morpholinophenyl)-butan-1-on, etc; a benzoin-based photo-polymerization initiator such as benzoin, benzoin methyl ether, benzoin ethyl ether, benzoin isopropyl ether, benzyldimethyl ketal, etc.; a benzophenone-based photo-polymerization initiator such as benzophenone, benzoylbenzoic acid, benzoylmethyl benzoate, 4-phenyl benzophenone, hydroxybenzophenone, acrylated benzophenone, 4-benzoyl-4′-methyldiphenyl sulfide, etc.; a thioxanthone-based photo-polymerization initiator such as thioxanthone, 2-chlorothioxanthone, 2-methylthioxanthone, isopropylthioxanthone, 2,4-diisopropylthioxanthone, etc.; a triazine-based photo-polymerization initiator such as 2,4,6-trichloro-s-triazine, 2-phenyl-4,6-bis(trichloromethyl)-s-triazine, 2-(p-methoxyphenyl)-4,6-bis(trichloromethyl)-s-triazine, 2-(p-tolyl)-4,6-bis(trichloromethyl)-s-triazine, 2-piperonyl-4,6-bis(trichloromethyl)-s-triazine, 2,4-bis(trichloromethyl)-6-styryl-s-triazine, 2-(naphtho-1-yl)-4,6-bis(trichloromethyl)-s-triazine, 2-(4-methoxynaphtho-1-yl)-4,6-bis(trichloromethyl)-s-triazine, 2,4-trichloromethyl-(piperonyl)-6-triazine, 2,4-trichloromethyl(4′-methoxystyryl)-6-triazine, etc.; an oxime ester-based photo-polymerization initiator such as 1-[4-(phenylthio)phenyl]-octan-1-one-2-oneoxime-O-acetate, 1-[4-(2-methylphenylthio)phenyl]-octan-1-one-2-oneoxime-O-acetate, 1-[4-(2,4,6-trimethylphenylthio)phenyl]-octan-1-one-2-oneoxime-O-acetate, 1-[4-(2-ethylphenylthio)phenyl]-octan-1-one-2-oneoxime-O-acetate, 1-[4-(phenylthio)phenyl]-octan-1-one-2-oneoxime-O-benzoate, 1-[4-(2-methylphenylthio)phenyl]-octan-1-one-2-oneoxime-O-benzoate, 1-[4-(2,4,6-trimethylphenylthio)phenyl]-octan-1-one-2-oneoxime-O-benzoate, 1-[4-(2-ethylphenylthio)phenyl]-octan-1-one-2-oneoxime-O-benzoate, 1,2-octadione-1-[(4-(phenylthio)phenyl-2-(O-benzoyloxime)], 1-[9-ethyl-6-benzoyl-9.H.-carbazol-3-yl]-octan-1-oneoxime-O-acetate, 1-[9-ethyl-6-(2-methylbenzoyl-9.H.-carbazol-3-yl]-ethan-1-oneoxime-O-acetate, 1-[9-ethyl-6-(2,4,6-trimethylbenzoyl)-9.H.-carbazol-3-yl]-ethan-1-oneoxime-O-benzoate, 1-[9-n-butyl-6-(2-ethylbenzoyl)-9.H.-carbazol-3-yl]-ethan-1-oneoxime-O-benzoate, ethanone, 1-[9-ethyl-6-(2-methylbenzoyl)-9H-carbazol-3-yl]-1-(O-acetyloxime), etc.; a borate-based photo-polymerization initiator; a carbazol-based photo-polymerization initiator; an acylphosphine oxide-based photo-polymerization initiator; an imidazole-based photo-polymerization initiator; etc. These photo-polymerization initiators can be employed singly or in combination of two or more kinds thereof.

In view of enhancing the sensitivity of the composition, the oxime ester-based photo-polymerization initiator is most preferable among the aforementioned photo-polymerization initiators. When the oxime ester-based photo-polymerization initiator absorbs ultraviolet rays, the cleavage of the N—O bond of oxime is caused to initiate, thereby generating an iminyl radical, benzoyloxy radical and alkyloxy radical. As these radicals are further decomposed, radicals exhibiting a higher activity are caused to generate, thereby making it possible to form a pattern with a small quantity of exposure.

The content of the photo-polymerization initiator is preferably confined to 5-200 parts by weight based on 100 parts by weight of the pigment. When the content of the photo-polymerization initiator is less than 5 parts by weight, it may become impossible to sufficiently secure the sensitivity of the composition even if a laser having an operating wavelength of 340-380 nm is employed, thereby necessitating an increase of exposure energy (intensity and time) for compensating the insufficiency of sensitivity, thus inviting a cause for the generation of roughened pixels. A more preferable range in content of the photo-polymerization initiator may be not less than 10 parts by weight based on 100 parts by weight of the pigment. On the other hand, when the content of the photo-polymerization initiator is larger than 200 parts by weight, the sensitivity of the composition may become too strong as a laser having an operating wavelength of 340-380 nm is employed, thereby deteriorating the linearity of pixels or deteriorating the cross-sectional configuration of pixels. More preferably, the content of the photo-polymerization initiator may be confined to not more than 150 parts by weight based on 100 parts by weight of the pigment.

Further, the ratio (I/M) of the weight (I) of the photo-polymerization initiator to the weight (M) of the monomer having an ethylenic unsaturated double bond is preferably confined to the range of 0.20-1.00. When this I/M is smaller than 0.20, it may become impossible to sufficiently secure the sensitivity of the composition even if a laser having an operating wavelength of 340-380 nm is employed, thereby increasing the possibility of peel-off of pixels and necessitating the increase of exposure energy (intensity and time) for compensating the insufficiency of sensitivity, thus inviting a cause for the generation of roughened pixels. More preferably, the ratio I/M is not less than 0.25, most preferably not less than 0.30. On the other hand, when this TIM is larger than 1.00, the sensitivity of the composition may become too strong as a laser having an operating wavelength of 340-380 nm is employed, thereby deteriorating the cross-sectional configuration of pixels. More preferably, the ratio TIM is not more than 0.9, most preferably not more than 0.80.

A photosensitizer may be employed together with the aforementioned photo-polymerization initiator. Specific examples of the photosensitizer include amine-based compounds such as triethanol amine, methyldiethanol amine, triisopropanol amine, 4-dimethylaminomethyl benzoate, 4-dimethylaminoethyl benzoate, 4-dimethylaminoisoamyl benzoate, 2-dimethylaminoethyl benzoate, 4-dimethylamino-2-ethylhexyl benzoate, N,N-dimethylparatoluidine, 4,4′-bis(dimethylamino) benzophenone, 4,4′-bis(diethylamino) benzophenone, 4,4′-bis(ethylmethylamino) benzophenone, etc. These photosensitizers can be employed singly or in combination of two or more kinds thereof. With respect to the mixing ratio of these photosensitizers, it is preferably confined to the range of 0.1-60 parts by weight based on 100 parts by weight of the photo-polymerization initiator.

(Polyfunctional Thiol)

The coloring composition according to the first embodiment of the present invention may contain a polyfunctional thiol. As for the polyfunctional thiol, it is possible to employ any kind of compound as long as it has two or more thiol (SH) groups.

When this polyfunctional thiol is used in combination with the aforementioned photo-polymerization initiator, it acts as a chain-transfer agent in the process of radical polymerization after the irradiation of light, resulting in the generation of thiyl radical which is not subject to the polymerization inhibition that may be caused by oxygen, thereby obtaining a coloring composition excellent in sensitivity. It is especially preferable to employ a polyfunctional aliphatic thiol where the SH group thereof is bonded to an aliphatic group such as methylene, ethylene, etc.

Specific examples of such a polyfunctional aliphatic thiol include hexane dithiol, decane dithiol, 1,4-butanediol bisthiopropionate, 1,4-butanediol bisthioglycolate, ethyleneglycol bisthioglycolate, ethyleneglycol bisthiopropionate, trimethylolpropane tristhioglycolate, trimethylolpropane tristhiopropionate, trimethylolpropane tris(3-mercaptobutylate), pentaerythritol tetrakisthioglycolate, pentaerythritol tetrakisthiopropionate, trimercaptopropionate tris(2-hydroxyethyl)isocyanulate, 1,4-dimethylmercaptobenzene, 2,4,6-trimercapto-s-triazine, 2-(N,N-dibutylamino)-4,6-dimercapto-s-triazine, etc. It is more preferable to employ ethyleneglycol bisthiopropionate, trimethylolpropane tristhiopropionate and pentaerythritol tetrakisthiopropionate.

These polyfunctional thiols can be employed singly or in combination of two or more kinds.

The content of these polyfunctional thiols is preferably confined to 0.05-100 parts by weight, more preferably 1.0-50.0 parts by weight based on 100 parts by weight of the pigment.

When the content of polyfunctional thiol is less than 0.05 part by weight, the effects thereof as a chain-transfer agent may become negligible even if a laser having an operating wavelength of 310 nm-380 nm is employed. Even if the content of polyfunctional thiol is increased beyond 100 parts by weight, it is impossible to expect any further improvement in the polymerization initiating function thereof and, furthermore, the developing properties and adhesive properties thereof may become insufficient.

When a blue pigment which is capable of strongly absorbing light of a wavelength in a region of 310 nm-380 nm is used in combination with the aforementioned oxime ester-based photo-polymerization initiator and polyfunctional thiol, it may be possible to obtain a filter segment which is free from the generation of surface wrinkling of coated film while retaining a high sensitivity in a laser exposure system using an operating wavelength of 310 nm-380 nm. In this case, it is preferable to employ, as an oxime ester-based photo-polymerization initiator, the compounds represented by the following general formula (1) or (2).

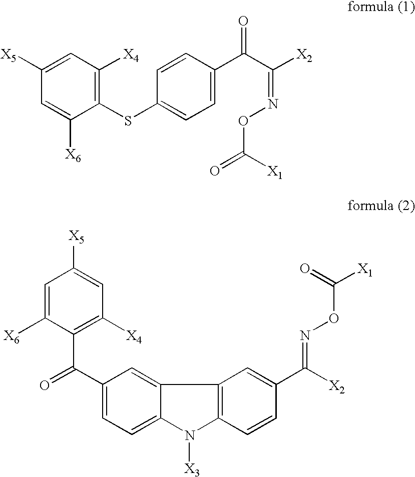

In the general formulas (1) and (2), X₁-X₆ represent respectively a hydrogen atom, a cyclic, linear or branched alkyl group having 1-12 carbon atoms or a phenyl group, wherein each of the alkyl group and phenyl group may be replaced by a substituent group selected from a halogen atom, alkoxyl group having 1-6 carbon atoms and phenyl group.

Specific examples of preferable compounds in the above general formulas (1) include 1-[4-(phenylthio)phenyl]-octan-1-one-2-oneoxime-O-acetate, 1-[4-(2-methylphenylthio)phenyl]-octan-1-one-2-oneoxime-O-acetate, 1-[4-(2,4,6-trimethylphenylthio)phenyl]-octan-1-one-2-oneoxime-β-acetate, 1-[4-(2-ethylphenylthio)phenyl]-octan-1-one-2-oneoxime-O-acetate, 1-[4-(phenylthio)phenyl]-octan-1-one-2-oneoxime-O-benzoate, 1-[4-(2-methylphenylthio)phenyl]-octan-1-one-2-oneoxime-O-benzoate, 1-[4-(2,4,6-trimethylphenylthio)phenyl]-octan-1-one-2-oneoxime-O-benzoate, 1-[4-(2-ethylphenylthio)phenyl]-octan-1-one-2-oneoxime-O-benzoate, 1,2-octadione-1-[(4-(phenylthio)phenyl-2-(O-benzoyloxime)], etc.

Further, specific examples of preferable compounds in the above general formulas (2) according to the present invention include 1-[9-ethyl-6-benzoyl-9.H.-carbazol-3-yl]-octan-1-oneoxime-O-acetate, 1-[9-ethyl-6-(2-methylbenzoyl-9.H.-carbazol-3-yl]-ethan-1-oneoxime-O-acetate, 1-[9-ethyl-6-(2,4,6-trimethylbenzoyl)-9.H.-carbazol-3-yl]-ethan-1-oneoxime-O-benzoate, 1-[9-n-butyl-6-(2-ethylbenzoyl)-9.H.-carbazol-3-yl]-ethan-1-oneoxime-O-benzoate, ethanone, 1-[9-ethyl-6-(2-methylbenzoyl)-9H-carbazol-3-yl]-1-(O-acetyloxime), etc.

Among these oxime ester-based photo-polymerization initiators, it is especially preferable to employ 1,2-octadione-1-[4-(phenylthio)phenyl-2-(O-benzoyloxime)], ethanone or 1-[9-ethyl-6-(2-methylbenzoyl)-9H-carbazol-3-yl]-1-(O-acetyloxime).

In the embodiment of the present invention, the oxime ester-based photo-polymerization initiator may be used as a mixture with one or more kinds of other photo-polymerization initiators.

(Polymerization Inhibitor)

The coloring composition according to the first aspect of the present invention may be formulated so as to contain a polymerization inhibitor. Although the polymerization inhibitor is generally employed as a stabilizing agent such as for the prevention of gelation of a composition, the polymerization inhibitor is employed in the present invention for the purpose of preventing the photo-sensitization of the composition by the diffracted light through a mask on exposure in addition to the aforementioned prevention of gelation. The problems caused by the photo-sensitization of the composition by the diffracted light through the mask include various phenomena, such as overhangs in the cross-sectional configuration of pixels, the generation of cut-outs of the edge portion of a pattern, and the excessive elongation of the tapered portion.

Specific examples of the polymerization inhibitor to be used in the photosensitive coloring composition include alkyl catechol-based compounds such as catechol, resorcinol, 1,4-hydroquinone, 2-methyl catechol, 3-methyl catechol, 4-methyl catechol, 2-ethyl catechol, 3-ethyl catechol, 4-ethyl catechol, 2-propyl catechol, 3-propyl catechol, 4-propyl catechol, 2-n-butyl catechol, 3-n-butyl catechol, 4-n-butyl catechol, 2-tert-butyl catechol, 3-tert-butyl catechol, 4-tert-butyl catechol, 3,5-di-tert-butyl catechol, etc.; alkyl resorcinol-based compounds such as 2-methyl resorcinol, 4-methyl resorcinol, 2-ethyl resorcinol, 4-ethyl resorcinol, 2-propyl resorcinol, 4-propyl resorcinol, 2-n-butyl resorcinol, 4-n-butyl resorcinol, 2-tert-butyl resorcinol, 4-tert-butyl resorcinol, etc.; alkyl hydroquinone-based compounds such as methyl hydroquinone, ethyl hydroquinone, propyl hydroquinone, tert-butyl hydroquinone, 2,5-di-tert-butyl hydroquinone, etc.; phosphine compounds such as tributyl phosphine, trioctyl phosphine, tricyclohexyl phosphine, triphenyl phosphine, tribenzyl phosphine, etc.; phosphine oxide compounds such as trioctyl phosphine oxide, triphenyl phosphine oxide, etc.; phosphite compounds such as triphenyl phosphite, tris-nonylphenyl phosphite, etc.; pyrogallol; phloroglucin; etc.

If a laser beam having a wavelength of 340-380 nm is to be used, it is more preferable to employ, among the aforementioned polymerization inhibitors, alkyl catechol-based compounds such as catechol, resorcinol, 1,4-hydroquinone; alkyl resorcinol-based compounds; and alkyl hydroquinone-based compounds. Especially preferable polymerization inhibitors are 1,4-hydroquinone and alkyl hydroquinone-based compounds. Compounds other than these compounds may not exhibit sufficient effects desired to be obtained.

The aforementioned polymerization inhibitors can be used singly or in combination of two of more kinds thereof.

With respect to the content of these polymerization inhibitors, it is preferably confined to 0.01-0.4 part by weight based on 100 parts by weight of a total weight of the photosensitive composition excluding the solvent. When the content of these polymerization inhibitors is less than 0.01 part by weight, it may not be possible to obtain sufficient effects to prevent the photo-sensitization of the composition by the diffracted light on the occasion of using a laser beam having a wavelength of 340-380 nm. More preferably, the content of these polymerization inhibitors may be not less than 0.05 part by weight. On the other hand, when the content of these polymerization inhibitors is more than 0.4 part by weight, the sensitivity of the photosensitive composition may be deteriorated on the occasion of using a laser beam having a wavelength of 340-380 nm. More preferably, the content of these polymerization inhibitors may be not more than 0.3 part by weight.

Although polymerization inhibitor is usually contained very little in the transparent resins or ethylenic unsaturated monomer available in the markets, in this embodiment, the polymerization inhibitors are added to the composition separately from the polymerization inhibitor which is usually contained in the commercially available transparent resins or ethylenic unsaturated monomer. Therefore, the weight of the polymerization inhibitor described herein means the weight excluding the weight of the compounds included in the commercially available transparent resins or ethylenic unsaturated monomer for the purpose of imparting stability to the composition.

(Optional Components)

The coloring composition according to the first embodiment of the present invention may further contain a storage stabilizing agent for stabilizing the viscosity with time of the composition. Further, the coloring composition according to the first embodiment of the present invention may contain an adherence improver such as a silane coupling agent for the purpose of enhancing the adhesion to the transparent substrate.

As for specific examples of the storage stabilizing agent, they include, for example, quaternary ammonium chlorides such as benzyltrimethyl chloride, diethylhydroxy amine, etc.; organic acids such as lactic acid, oxalic acid, etc. and methyl ethers thereof; t-butyl pyrocatechol; organic phosphines such as tetraethyl phosphine, tetraphenyl phosphine, etc.; phosphite; etc. The storage stabilizing agent can be employed at a ratio of 0.1-10 parts by weight based on 100 parts by weight of the pigment in a coloring composition.

As for specific examples of the silane coupling agent, they include vinyl silanes such as vinyl tris(β-methoxyethoxy) silane, vinylethoxy silane, vinyltrimethoxy silane, etc.; (metha)acrylsilanes such as γ-methacryloxypropyl silane, etc.; epoxy silanes such as β-(3,4-epoxycyclohexyl)ethyltrimethoxy silane, β-(3,4-epoxycyclohexyl)methyltrimethoxy silane, β-(3,4-epoxycyclohexyl)ethyltriethoxy silane, β-(3,4-epoxycyclohexyl)methyltriethoxy silane, γ-glycidoxypropyl trimethoxy silane, γ-glycidoxypropyl triethoxy silane, etc.; amino silanes such as N-β(aminoethyl) γ-aminopropyl trimethoxy silane, N-β(aminoethyl) γ-aminopropyl triethoxy silane, N-β(aminoethyl) γ-aminopropyl methyldiethoxy silane, γ-aminopropyl triethoxy silane, γ-aminopropyl trimethoxy silane, N-phenyl-γ-aminopropyl trimethoxy silane, N-phenyl-γ-aminopropyl triethoxy silane, etc.; and thiosilanes such as γ-mercaptopropyl trimethoxy silane, γ-mercaptopropyl triethoxy silane, etc. These silane coupling agents can be used at a ratio of 0.01-10 parts by weight, preferably 0.05-5 parts by weight based on 100 parts by weight of the pigment in a coloring composition.

The coloring composition of the first embodiment of the present invention may further contain a solvent for enabling pigments to be sufficiently dispersed in the coloring composition and for coating the coloring composition at a dry thickness of 0.2 μm-5 μm on a transparent substrate such as a glass substrate, thus facilitating the formation of the filter segments or the black matrix.

Specific examples of the solvent include 1,2,3-trichloropropane, 1,3-butanediol, 1,3-butylene glycol, 1,3-butylene glycol diacetate, 1,4-dioxane, 2-heptane, 2-methyl-1,3-propanediol, 3,5,5-trimethyl-2-cyclohexen-1-one, 3,5,5-trimethyl cyclohexanone, 3-ethoxyethyl propionate, 3-methyl-1,3-butanediol, 3-methoxy-3-methyl-1-butanol, 3-methoxy-3-methylbutyl acetate, 3-methoxybutanol, 3-methoxybutyl acetate, 4-heptanone, m-xylene, m-diethylbenzene, m-dichlorobenzene, N,N-dimethyl acetoamide, N,N-dimethyl formamide, n-butyl alcohol, n-butyl benzene, n-propyl acetate, N-methylpyrrolidone, o-xylene, o-chlorotoluene, o-diethyl benzene, o-dichlorobenzene, p-chlorotoluene, p-diethyl benzene, sec-butyl benzene, tert-butyl benzene, γ-butyrolactone, isobutyl alcohol, isophorone, ethyleneglycol diethyl ether, ethyleneglycol dibutyl ether, ethyleneglycol isopropyl ether, ethyleneglycol monoethyl ether, ethyleneglycol monoethyl ether acetate, ethyleneglycol monotertiary butylether ether, ethyleneglycol monobutyl ether, ethyleneglycol monobutylether acetate, ethyleneglycol monopropyl ether, ethyleneglycol monohexyl ether, ethyleneglycol monomethyl ether, ethyleneglycol monomethylether acetate, diisobutyl ketone, diethylglycol diethyl ether, diethylglycol dimethyl ether, diethylglycol monoisopropyl ether, diethyleneglycol monoethylether acetate, diethyleneglycol monobutyl ether, diethyleneglycol monobutylether acetate, diethyleneglycol monomethyl ether, cyclohexanol, cyclohexanol acetate, cyclohexane, dipropyleneglycol dimethyl ether, dipropyleneglycol methylether acetate, dipropyleneglycol monoethyl ether, dipropyleneglycol monobutyl ether, dipropyleneglycol monopropyl ether, dipropyleneglycol monomethyl ether, diacetone alcohol, treacetylene, tripropyleneglycol monobutyl ether, tripropyleneglycol monomethyl ether, propyleneglycol diacetate, propyleneglycol phenylether, propyleneglycol monoethyl ether, propyleneglycol monoethylether acetate, propyleneglycol monobutyl ether, propyleneglycol monopropyl ether, propyleneglycol monomethyl ether, propyleneglycol monomethylether acetate, propyleneglycol monomethylether propionate, benzyl alcohol, methylisobutyl ketone, methylcyclohexanol, n-amyl acetate, n-butyl acetate, isoamyl acetate, isobutyl acetate, propyl acetate, dibasic acid ester, etc. These compounds can be used singly or in combination of two or more kinds thereof.

When pigments are dispersed in a transparent resin, a dispersing agent such as a surfactant, a resin type pigment dispersing agent, a pigment derivative, etc. can be optionally used. Since these dispersing agents are excellent in enhancing the dispersibility of pigments and in prevention of re-flocculation of pigments after the dispersion thereof, when these dispersing agents are used for dispersing pigments in a transparent resin and in an organic solvent in the preparation of the coloring composition, it may be possible to obtain a color filter which is excellent in transparency. These pigment-dispersing agents can be used at a ratio of 0.1-40 parts by weight, preferably 0.1-30 parts by weight based on 100 parts by weight of the pigment in a coloring composition.

As for this surfactant, it is possible to employ, for example, an anionic surfactant such as polyoxyethylene alkylether sulfate, dodecylbenzene sodium sulfonate, alkali salts of a styrene-acrylic acid copolymer, alkylnaphthaline sodium sulfonate, alkyldiphenyl ether sodium disulfonate, monoethanol amine lauryl sulfate, triethanol amine lauryl sulfate, ammonium lauryl sulfate, monoethanol amine stearate, sodium stearate, sodium lauryl sulfate, monoethanol amine of styrene-acrylic acid copolymer, polyoxyethylene alkylether phosphate, etc.; a nonionic surfactant such as polyoxyethylene oleyl ether, polyoxyethylene lauryl ether, polyoxyethylene nonylphenyl ether, polyoxyethylene alkylether phosphate, polyoxyethylene sorbitan monostearate, polyethyleneglycol monolaurate, etc.; cationic surfactant such as alkyl quaternary ammonium salt and an ethylene oxide adduct thereof, etc.; and an amphoteric surfactant such as alkyl betaine such as betaine alkyldimethyl aminoacetate, alkylimidazoline, etc. Further, it is also possible to employ fluorine-based or silicon-based surfactants.

The resin type pigment dispersing agent is formed of a resin having not only a pigment affinity moiety exhibiting pigment-adsorbing properties, but also a moiety exhibiting compatibility to the transparent resin, thereby enabling the dispersing agent to adsorb onto the pigment and to stabilize the dispersion of the pigment in the transparent resin. As for specific examples of the resin type pigment dispersing agent, they include polyurethane, polycarboxylate such as polyacrylate, unsaturated polyamide, polycarboxylic acid, (partial) amine polycarboxylate, ammonium polycarboxylate, alkyl amine polycarboxylate, polysiloxane, long chain polyaminoamide phosphate, hydroxyl group-containing polycarboxylate and modified compounds thereof, an oily dispersing agent such as amide formed through a reaction between poly(lower alkyl imine) and polyester having a free carboxyl group and salts of the amide, (metha)acrylic acid-styrene copolymer, (metha)acrylic acid-(metha)acrylate copolymer, styrene-maleic acid copolymer, water-soluble resin or water-soluble macromolecular compound such as polyvinyl alcohol and poly(vinyl pyrrolidone), polyester compounds, modified polyacrylate compounds, ethylene oxide/propylene oxide adduct, phosphate, etc. These compounds may be employed individually or in combination of two or more kinds.

As for specific examples of the resin type pigment dispersing agent which are available on the market, they include Disperbyk-101, 103, 107, 108, 110, 111, 116, 130, 140, 154, 161, 162, 163, 164, 165, 166, 170, 171, 174, 180, 181, 182, 183, 184, 185, 190, 2000, 2001; Anti-Terra-U, 203, 204; or BYK-P104, P104S, 220S; or Lactimon, Lactimon-WS or Bykumen (all available from BigChemy Co., Ltd.); SOLSPERSE-3000, 9000, 13240, 13650, 13940, 17000, 18000, 20000, 21000, 24000, 26000, 27000, 28000, 31845, 32000, 32500, 32600, 34750, 36600, 38500, 41000, 41090, 53095 (all available from Nippon Lubrizole Co., Ltd.); EFKA-46, 47, 48, 452, LP4008, 4009, LP4010, LP4050, LP4055, 400, 401, 402, 403, 450, 451, 453, 4550, LP4560, 120, 150, 1501, 1502, 1503 (all available from Efca Chemicals Co., Ltd.).

The pigment derivative is formed of a compound comprising an organic pigment having a substituent group introduced therein. This organic pigment includes aromatic polycyclic compounds exhibiting a light yellow color such as naphthalene-based compounds, anthraquinone-based compounds which are generally not referred to as pigments. As for specific examples of the pigment derivatives, it is possible to employ those described in JP-A 63-305173, JP-A 57-15620, JP-A 59-40172, JP-A 63-17102 and JP-A 5-9469. These pigment derivatives may be employed individually or in combination of two or more kinds.

(Preparation of Coloring Compositions)

The coloring composition according to the first embodiment of the present invention can be manufactured as follows. Namely, by making use of various kinds of dispersing device such as a triple roll mill, a twin-roll mill, a sand mill, a kneader, an attritor, etc., a pigment is finely dispersed, if required together with any of the aforementioned dispersing agents, in a transparent resin and an organic solvent to obtain a mixture to which a photo-polymerization initiator is added to obtain the coloring composition. In the manufacture of the coloring composition containing two or more kinds of pigments, the pigments are individually finely dispersed in a transparent resin and an organic solvent, and then the dispersions thus obtained are mixed together.

The color composition is preferably formulated such that bulky particles 5 μm or more in size, preferably, bulky particles 1 μm or more in size, more preferably, bulky particles 0.5 μm or more in size as well as dusts intermingled therein are removed from the composition by making use of any suitable means such as centrifugal separation, sintered filter, membrane filter, etc.

Next, the method of manufacturing a color filter according to the second embodiment of the present invention by making use of the coloring compositions prepared as described above will be explained.

The method of manufacturing a color filter according to the second embodiment of the present invention is featured in that it comprises: coating any of the aforementioned coloring compositions on a substrate to form a color coated film; irradiating a filter segment-forming region or a black matrix-forming region of the color coated film with a laser beam having a wavelength of 340-380 nm, thereby curing the irradiated region; and removing uncured portions of the color coated film to form the filter segment or the black matrix.

According to the manufacturing method of a color filter as described above, since the photosensitive coloring composition can be cured in a very short time through the irradiation of a laser beam having a specific wavelength for a short period of time, it is possible to form a filter segment excellent in configuration at low cost with or without the employment of a small photomask.

Next, each of the processes in the manufacturing method of a color filter according to the second embodiment will be explained.

(Color Coated Film-forming Process)

In the color coated film-forming process, a coloring composition according to the first embodiment of the present invention is coated on a substrate by means of a spin coating method or a die coating method, and then, if required, any excess solvent is removed to form a color coated film on the substrate.

With respect to the substrate for the color filter, it is possible to employ a glass plate which is high in transmittance to visible light, such as soda-lime glass, low alkali borosilicate glass, alkali-free aluminoborosilicate glass, etc. or to employ a resin plate formed of a material such as polycarbonate, poly(methyl methacrylate), polyethylene terephthalate, etc. For the purpose of driving the liquid crystal after the fabrication of a liquid crystal panel, a transparent electrode made of indium oxide or tin oxide may be formed on the surface of the glass plate or resin plate.

(Exposure/curing Process)

In the exposure/curing process, a laser beam having a wavelength of 340-380 nm is irradiated to a filter segment-forming region or a black matrix-forming region of the color coated film, thereby curing the irradiated region. Specifically, the laser beam is irradiated, through a relatively small photomask as compared with the size of a substrate, to the color coated film which has been formed on the surface of this large size substrate, thereby curing the filter segment-forming region or the black matrix-forming region of the color coated film.

With respect to the wavelength of the laser beam, it is preferably confined to 340-380 nm. When a laser beam having a wavelength shorter than 340 nm is used, the energy of light may become too high, so that the decomposition of the coated film may be caused to occur. Further, when a laser beam having a wavelength longer than 380 nm is used, the energy of light may become too weak, so that the exposure of a longer period of time may be required for curing the coated film, thereby decreasing the productivity. The light source for the laser beam having a wavelength of 340-380 nm includes a solid (YAG) laser having an operating wavelength of 343 nm or 355 nm, a (XeG) excimer laser having an operating wavelength of 351 nm, and a semiconductor laser having an operating of. Among them, The light source having a wavelength of 355 nm is more preferable in terms of stability and cost. The laser beam may be irradiated to the color coated film at one time or the laser irradiation may be divided into a plurality of times. It is essential to cure the color coated film by the employment of such a weak energy that may not decompose the film.

The energy density of laser beam per pulse to be employed in the present invention is preferably confined to 0.1 mJ/cm²-10000 mJ/cm². In order to sufficiently cure the coated film, the energy density of the laser beam is more preferably not less than 0.3 mJ/cm², and most preferably not less than 0.5 mJ/cm². In order to prevent the decomposition of color coated film that may be caused due to the ablation phenomenon, the energy density of the laser beam may more preferably be not more than 1000 mJ/cm², most preferably not more than 100 mJ/cm².

Further, with respect to the pulse width, it is preferably confined to 0.1 nsec-30,000 nsec. In order to prevent the decomposition of color coated film that may be caused due to the ablation phenomenon, the pulse width is more preferably not less than 0.5 nsec, most preferably not less than lnsec. In order to enhance the alignment precision on the occasion of scanning exposure, the pulse width is more preferably be not more than 1,000 nsec, most preferably not less than 5 nsec.

Further, with respect to the frequency of the laser beam, it is preferably confined to 1 Hz-50,000 Hz. In order to shorten the exposure treatment time, the frequency of the laser beam is more preferably not less than 10 Hz, most preferably not less than 100 Hz. In order to enhance the alignment precision on the occasion of scanning exposure, the frequency of the laser beam is more preferably not more than 10,000 Hz, most preferably not more than 1,000 Hz.

(Uncured Portion-removing Process)

In the process of removing an uncured portion, the uncured portion of the color coated film is removed to create filter segments, i.e., a black matrix. As for the alkaline developing solution to be employed on the occasion of removing uncured portion, it is possible to employ an aqueous solution of sodium carbonate, sodium hydroxide, etc. or to employ an organic alkaline solution such as dimethylbenzyl amine, triethanol amine, etc. Further, if required, the developing solution may contain a defoaming agent or a surfactant.

As for the method of the developing treatment, it is possible to employ a shower developing method, a spray developing method, a dip developing method, a paddle developing method, etc.

(Exposure Process after Developing Process)

In the method of manufacturing the color filter according to the second embodiment of the present invention, after finishing the development, an exposure treatment may further be applied to the coated surface and/or the rear surface of the substrate. In the exposure/curing processes for the development, the interior of the coated film may be sometimes left uncured even if the coated surface of the substrate is sufficiently cured. Therefore, when the heat baking of the substrate is performed after the developing treatment, the adhesion between the coated film and the substrate may be deteriorated or wrinkles may be sometimes generated on the coated surface of the substrate. In the case of a blue color-coated film, since the absorption of laser beam employed in the exposure for the development is especially strong, the propensity for the aforementioned phenomena to occur is especially strong. These phenomena can be overcome by promoting the curing of the interior of coated film by subjecting the coated surface and/or the rear surface of the substrate to post-exposure after finishing the developing treatment.

The step of exposure to be applied to the substrate through the coated surface and/or the rear surface of the substrate after finishing the developing treatment can be performed by irradiating these surfaces with an active energy beam so as to promote the curing of the bottom portion of the color'coated film. As for the active energy beam, it is possible to employ an electron beam, ultraviolet rays, visible light having a wavelength of 400-500 nm, and various kinds of laser beam. As for the radiation source of the electron beam, it is possible to employ a thermoelectron radiating gun, a field emission gun, etc. With respect to the radiation source of ultraviolet rays and the visible light having a wavelength of 400-500 nm, it is possible to employ, for example, a high-pressure mercury lamp, an ultra-high-pressure mercury lamp, a metal halide lamp, gallium lamp, a xenon lamp, a carbon arc lamp, etc. As for the active energy beam, the employment of an energy beam having a wavelength which is excellent in transmissivity to the color coated film is especially effective in promoting the curing of the interior of the coated film.

The irradiation of the active energy beam need not necessarily be performed through only one of the coated surface side and the rear side of the substrate, and may be performed through both the coated surface side and the rear side of the substrate. When the irradiation of the active energy beam is to be applied to the substrate through both of these surfaces, the irradiation of the active energy beam can be performed simultaneously or alternately, i.e. at first through the front surface and then through the rear surface, and vice versa.

The color filter according to the third embodiment of the present invention can be manufactured by the manufacturing method according to the second embodiment of the present invention and is provided, on the surface of the substrate, with a black matrix and/or filter segments exhibiting at least one color, each being created by making use of the aforementioned coloring compositions. As for the color of the filter segments, colors of around 2-6 kinds selected from red, green, blue, yellow, violet, magenta, cyan, orange, etc. can be employed. Filter segments exhibiting the same kinds of color but with different concentrations may be formed.

These color filters are excellent in quality and low in manufacturing cost, so that they can be suitably employed in the manufacture of a liquid crystal display device, etc.

### EXAMPLES

Next, the present invention will be explained in detail with reference to specific examples, which are not intended to limit the scope of the present invention but can be variously modified as long they do not depart from the inventive concept of the present invention.

Incidentally, “part(s)” and “%” mentioned in examples and comparative examples means “part(s) by weight” and “% by weight”, respectively.

First of all, the preparation of a non-photosensitive resin solution, a photosensitive resin solution and a pigment dispersion, which were employed in the following Examples and Comparative Examples, will be explained. The molecular weight of the resin was a weight average molecular weight reduced as polystyrene and measured by means of GPC (gel permeation chromatography).

(Synthesis of Acrylic Resin Solution)

370 parts of cyclohexanone was put into a reaction vessel and heated at a temperature of 80° C. while introducing nitrogen gas into the reaction vessel and then, while maintaining this temperature, a mixture of 20.0 parts of methacrylic acid, 10.0 parts of methyl methacrylate, 55.0 parts of n-butyl methacrylate, 15.0 parts of 2-hydroxyethyl methacrylate and 4.0 parts of 2,2′-azobis-isobutyronitrile was added dropwise to the cyclohexanone over one hour, thereby allowing a polymerization reaction to take place. After finishing the addition of the aforementioned mixture, the reaction of this mixture was further allowed to take place for 3 hours at a temperature of 80° C. Thereafter, a solution obtained by dissolving 1.0 part of azobis-isobutyronitrile in 50 parts of cyclohexanone was added to the reaction mixture and the reaction thereof was continued for one hour at a temperature of 80° C. to obtain a solution of acrylic resin.

After being cooled down to room temperature, about 2 g of this acrylic resin solution was sampled out and thermally dried for 20 minutes at 180° C. to measure nonvolatile matter. Based on this measurement result, a suitable amount of cyclohexanone was added to the acrylic resin solution that had been synthesized in advance so as to cause the content of the nonvolatile matter to become 20%, thus preparing the acrylic resin solution. The weight average molecular weight (Mw) of the acrylic resin thus obtained was 40,000.

(Preparation of Pigment Dispersion)

A mixture having a composition shown in the following Table 1 was homogeneously stirred and then, by making use of a sand mill using glass beads having a diameter of 1 mm, the dispersion of the components of the composition was performed for 5 hours and the resultant product was subjected to filtration by making use of a 5 μm aperture filter to obtain a red pigment dispersion R-1, a green pigment dispersion G-1, a blue pigment dispersion B-1 and a black pigment dispersion BM-1, respectively.

TABLE 1
Formulation of pigment dispersion (part(s))

| Pigment dispersion | | R-1 | G-1 | B-1 | BM-1 |
|---|---|---|---|---|---|
| Pigment | PR254 | 9.95 | | | |
| | PR177 | 1.58 | | | |
| | PG36 | | 7.82 | | |
| | PB15: 6 | | | 12.00 | |
| | PY150 | 0.47 | 4.18 | | |
| | CB | | | | 12.00 |

| | | | | |
|---|---|---|---|---|
| Pigment dispersant | 2.40 | 2.40 | 2.40 | 2.40 |
| Acrylic resin solution | 25.60 | 25.60 | 25.60 | 25.60 |
| Organic solvent | 60.00 | 60.00 | 60.00 | 60.00 |
| Total | 100.00 | 100.00 | 100.00 | 100.00 |

PR254: Diketopyrrolopyrrole-based pigment (C.I. Pigment Red 254)(“IRGAPHOR RED B-CF”; Ciba-Japan Co., Ltd.).
PR177: Anthraquinone-based pigment (C.I. Pigment Red 177)(“CROMOPHTAL RED A2B”; Ciba-Japan Co., Ltd.).
PG36: Halogenated copper phthalocyanine-based pigment (C.I. Pigment Green 36)(“LYONOL GREEN 6YK”; Toyo Ink Manufacturing Co., Ltd.).
PB15:6: ε type copper phthalocyanine-based pigment (C.I. Pigment Blue 15:6) (“Heliogen Blue-L-6700F”; BASF Co., Ltd.).
PY150: Nickel/azo complex-based pigment (C.I. Pigment Yellow 150) (“E4GN”; Lancces Co., Ltd.).
CB: Carbon black (C.I. Pigment Black 7) (“MA11”; Mitsubishi Chemicals Co., Ltd.).
Pigment dispersant: “Solsperse 20000”; Nippon Lubrisol Co., Ltd.)
Acrylic resin solution: Acrylic resin solution prepared as described above.
Solvent: Cyclohexanone

### Examples 1-32 and Comparative Examples 1-14

Each of the mixtures having the formulation shown in the following Tables 2 and 3, each containing the pigment dispersions R-1, G-1, B-1 and BM-1 prepared in advance, was homogeneously stirred and each of the resultant mixtures was subjected to filtration by making use of a 1 μm aperture filter to obtain each of the coloring compositions.

TABLE 2

| | | | Resist | | | | | | | | |
|---|---|---|---|---|---|---|---|---|---|---|---|
| | | | RR-1 | RR-2 | RR-3 | RR-4 | RR-5 | RR-6 | RR-7 | RR-8 | RR-9 |
| Pigment dispersion (type) | | | R-1 | R-1 | R-1 | R-1 | R-1 | R-1 | R-1 | R-1 | R-1 |
| Composition | Pigment | | 40.0 | 40.0 | 40.0 | 40.0 | 40.0 | 40.0 | 40.0 | 40.0 | 40.0 |
| | dispersion | | | | | | | | | | |
| | Acrylic resin | | 20.3 | 20.3 | 20.3 | 26.3 | 6.8 | 18.8 | 16.8 | 7.8 | 7.8 |
| | solution | | | | | | | | | | |
| | Polymerization | | 1.0 | 1.0 | 1.0 | 1.0 | 1.0 | 0.5 | 1.9 | 1.5 | 1.5 |
| | initiator 1 | | | | | | | | | | |
| | Polymerization | | | | | | | | | | |
| | initiator 2 | | | | | | | | | | |
| | Polymerization | | | | | | | | | | |
| | initiator 3 | | | | | | | | | | |
| | Monomer | M1 | 2.0 | | | | | | | | |
| | | M2 | | 2.0 | | 0.8 | 4.7 | 2.8 | 1.8 | 4.0 | 4.0 |
| | | M3 | | | 2.0 | | | | | | |

| | | | | | | | | | |
|---|---|---|---|---|---|---|---|---|---|
| Polyfunctional | | | | | | | | | |
| thiol | | | | | | | | | |
| 1% solution of | | | | | | | | | 1.0 |
| polymerization | | | | | | | | | |
| inhibitor | | | | | | | | | |
| Organic solvent | 36.7 | 36.7 | 36.7 | 31.9 | 47.5 | 37.9 | 39.5 | 46.7 | 45.7 |
| Total | 100.0 | 100.0 | 100.0 | 100.0 | 100.0 | 100.0 | 100.0 | 100.0 | 100.0 |

| | | | | | | | | | |
|---|---|---|---|---|---|---|---|---|---|
| M/P | 0.33 | 0.33 | 0.33 | 0.11 | 1.38 | 0.48 | 0.33 | 1.11 | 1.11 |
| I/M | 0.50 | 0.50 | 0.50 | 1.25 | 0.21 | 0.18 | 1.06 | 0.38 | 0.38 |

TABLE 3

| | | | Resist | | | | |
|---|---|---|---|---|---|---|---|
| | | | GR-1 | BR-1 | BR-2 | BR-3 | BMR-1 |
| Pigment dispersion (type) | | | G-1 | B-1 | B-1 | B-1 | BM-1 |
| Composition | Pigment | | 45.0 | 34.0 | 34.0 | 34.0 | 46.0 |
| | dispersion | | | | | | |
| | Acrylic resin | | 7.5 | 14.0 | 24.0 | 24.0 | 2.6 |
| | solution | | | | | | |
| | Polymerization | | 1.5 | 2.3 | | | 2.1 |
| | initiator 1 | | | | | | |
| | Polymerization | | | | 0.8 | | |
| | initiator 2 | | | | | | |
| | Polymerization | | | | | 0.8 | |
| | initiator 3 | | | | | | |
| | Monomer | PE4A | | | | | |
| | | DPHA | 2.0 | 4.4 | 3.0 | 3.0 | 3.6 |
| | | DPPAH | | | | | |

| | | | | | |
|---|---|---|---|---|---|
| Polyfunctional | | | 1.0 | 2.0 | |
| thiol | | | | | |
| 1% solution of | | | | | |
| polymerization | | | | | |
| inhibitor | | | | | |
| Organic solvent | 44.0 | 45.3 | 36.0 | 40.0 | 46.3 |
| Total | 100.0 | 100.0 | 98.8 | 103.8 | 100.6 |

| | | | | | |
|---|---|---|---|---|---|
| M/P | 0.53 | 0.97 | 0.46 | 0.46 | 1.25 |
| I/M | 0.75 | 0.52 | 0.27 | 0.27 | 0.58 |

Pigment dispersion: Pigment dispersion prepared as described above.
Acrylic resin solution: Acrylic resin solution prepared as described above.
Photo-polymerization initiator: Ones shown in the following Table 4.
Monomer: Monomers shown in the following Table 5.
Polyfunctional thiol: Trimethylolpropane tristhiopropionate.
1% cyclohexanone solution of methylhydroquinone ((MH); Seiko Kagaku Co., Ltd.)
Organic solvent: Cyclohexane.

TABLE 4

| | Photo-polymerization initiator |
|---|---|
| Polymerization | 2-methyl-1-[4-(methylthio)phenyl]-2-morpholinopropan- |
| initiator 1 | 1-one (“IRGACURE 907”; Ciba-Japan Co., Ltd.) |
| Polymerization | 1-[9-ethyl-6-(2-methylbenzoyl)-9H-carbazol-3-yl]-1- |
| initiator 2 | (O-acetyloxime) (“IRGACURE OXE02”; Ciba-Japan |
| | Co., Ltd.) |
| Polymerization | 1,2-octadione-1-[4-(phenylthio)phenyl-2-(O- |
| initiator 3 | benzoyloxime)] (“IRGACURE OXE01”; Ciba-Japan |
| | Co., Ltd.) |

TABLE 5

| | | | Number of |
|---|---|---|---|
| Abbreviation | Polyfunctional monomer | | functional group |
| M1 | Pentaerythritol tetraacrylate | (“ARONIX M450”; | 4 |
| | | Toua Gosei Co., Ltd.) | |
| M2 | Dipentaerythritol pentaacrylate | (“RS-399E”; | 5 |
| | | SirThomer Co., Ltd.) | |
| M3 | Caprolactone-modified | (“Kayarad DPCA-20”; | 6 |
| | dipentaerythritol hexaacrylate | Nippon Kayaku Co., Ltd.) | |

(Formation of Patterns of Filter Segments and Black Matrix)

By means of spin coating, each of the coloring compositions thus obtained was coated on the surface of a glass substrate 10 cm×10 cm in size to obtain a coated film having a thickness of about 2 μm, which was then left to stand for 15 minutes in an oven at a temperature of 70° C., thereby removing any excess solvent. Then, a photomask having a stripe-like pattern (100 μm in line width in the case of the filter segments and 20 μm in line width in the case of the black matrix) was set over the coated film of the coloring composition with a gap of 150 μm being interposed between the coated film and the photomask. Then, the light from the light sources shown in the following Table 6 was irradiated to the coated films of the coloring compositions. Incidentally, the dosage of exposure was measured by making use of “3-sigma (main part) PS-10 (sensor head)” (Coherent Co., Ltd.). Further, by making use of a developing solution formed of a 2% aqueous solution of sodium carbonate, a spray development was performed to remove an unexposed portion of the coated film. The resultant substrate was then washed with ion-exchange water.

TABLE 6
Light source

| | Wavelength | |
|---|---|---|
| Abbreviation | of laser | Type of light source |
| A | 355 nm | Solid (YAG) laser |
| B | 351 nm | Excimer (XeF) laser |
| C | 343 nm | Solid (YAG) laser |
| D | 375 nm | Semiconductor laser |
| E | 308 nm | Excimer (XeF) laser |
| F | 405 nm | Semiconductor laser |
| G | — | Ultra-high pressure mercury lamp |
| H | — | Metal halide lamp |

(Process of Exposure/curing after Development)

Subsequently, the exposure/curing after development was performed on the resultant substrate by irradiating the coated surface or the rear surface of the substrate with the light from each of the light sources shown in above Table 6. On this occasion, the application of exposure to the coated surface was performed by irradiating the light at a dosage of 100 mJ/cm² in each wavelength in the case of the exposure to the coated surface of the substrate and at a dosage of 5 mJ/cm² in each wavelength in the case of the exposure to the rear surface of the substrate. Following Tables 7-10 show the use or non-use of the exposure/curing process, the exposure light sources and the surface of exposure.

Thereafter, the substrate was heated for 30 minutes at 230° C. to form colored filter segments (red, green and blue) and the black matrix (black) of Examples 1-32 and Comparative Examples 1-14.

Then, the sensitivity and the pattern configuration obtained from the coloring compositions of these examples and comparative examples were assessed.

(Sensitivity)

The sensitivity of these compositions was determined based on the dosage of exposure sufficient to enable the patterns of the filter segments and the black matrix obtained via these examples and comparative examples to precisely conform to the predetermined image of the photomask. The ranking of assessment was as follows. The results are shown in the following Tables 7-10.

⊚: Less than 30 mJ/cm²

◯: 30 mJ/cm²-less than 60 mJ/cm²

Δ: 60 mJ/cm²-less than 100 mJ/cm²

X: Not less than 100 mJ/cm²

(Assessment of the Pattern Configuration)

With respect to the linearity (1) of the filter segments and the black matrix which were formed with the dosage of exposure sufficient to enable the patterns thereof to precisely conform to the predetermined image of the photomask in above Examples and Comparative Examples, the assessment thereof was performed by making use of an optical microscope. Assessment of the sectional configuration (2) thereof was performed by observation using a scanning electron microscope. These assessments of the pattern configuration were classified into four ranks. The standard of assessment was as follows, the results being illustrated in the following Tables 7-10.

Linearity

◯: Excellent in linearity

Δ: Linearity was poor in parts

X: Linearity was poor

XX: Pixels were substantially not formed

(2) Sectional Configuration

◯: Normally tapered (trapezoidal in cross-section and the surface exposed for the first time was small)

Δ: Reversely tapered (trapezoidal in cross-section and the surface exposed for the first time was large)

X: Although pixels were created, it was difficult to judge the configuration thereof.

XX: Pixels were substantially not formed

(Film Peeling and Surface Wrinkling of Coated Film)

The film peeling (1) and the surface wrinkling (2) of the colored filter segments and the black matrix were assessed by observation using an optical microscope. The standard of assessment was as follows, the results being illustrated in the following Tables 7-10.

(1) Film Peeling of Coated Film

◯: No peeling was observed

Δ: Peeling was observed in parts

X: Peeling was observed all over the surface

(2) Surface Wrinkling of Coated Film

◯: No wrinkling was observed

Δ: Wrinkling was observed in parts

X: Wrinkling was observed all over the surface

(Adhesion of Black Matrix to Substrate)

By making use of a pressure cooker tester, the adhesion of each of the black matrixes of Examples 25-32 and Comparative Examples 12-14 was assessed. Namely, these black matrixes were left to stand for 50 hours under the conditions of: 120° C., 100% RH and 2 atm. Then, the resultant black matrixes were assessed by the cross-cut adhesion test based on JIS K5400, wherein the extent of peeling in 100 portions of the cross-cut was measured. The standard of assessment was as follows, the results being illustrated in the following Table 10.

◯: There was no peeling in any of 100 portions

Δ: Peeling was present in less than 10 of 100 portions

X: Peeling was present in 10 or more of 100 portions

TABLE 7

| | | Example | Example | Example | Comparative | Comparative | Example | Example | Example |
|---|---|---|---|---|---|---|---|---|---|
| | | 1 | 2 | 3 | Example 1 | Example 2 | 4 | 5 | 6 |
| Color | | Red | Red | Red | Red | Red | Red | Red | Red |
| Resist | | RR-1 | RR-2 | RR-3 | RR-4 | RR-5 | RR-6 | RR-7 | RR-2 |
| Light source for | | A | A | A | A | A | A | A | B |
| exposure/curing step | | | | | | | | | |
| Curing process | Light | None | None | None | None | None | None | None | None |
| through coated | source | | | | | | | | |
| surface or rear | Exposure | None | None | None | None | None | None | None | None |
| surface of | surface | | | | | | | | |
| substrate | | | | | | | | | |

| | | | | | | | | |
|---|---|---|---|---|---|---|---|---|
| Sensitivity | Δ | ◯ | ⊚ | X | ⊚ | Δ | ◯ | ◯ |
| Linearity | ◯ | ◯ | ◯ | ◯ | Δ | ◯ | ◯ | ◯ |
| Sectional configuration | ◯ | ◯ | ◯ | Δ | X | ◯ | ◯ | ◯ |
| Peeling of coated film | ◯ | ◯ | ◯ | ◯ | ◯ | ◯ | ◯ | ◯ |
| Surface wrinkling of | ◯ | ◯ | ◯ | ◯ | ◯ | ◯ | ◯ | ◯ |
| coated film | | | | | | | | |

| | | Example | Example | Comparative | Comparative | Comparative | Example | Example |
|---|---|---|---|---|---|---|---|---|
| | | 7 | 8 | Example 3 | Example 4 | Example 5 | 9 | 10 |
| Color | | Red | Red | Red | Red | Red | Red | Red |
| Resist | | RR-2 | RR-2 | RR-2 | RR-2 | RR-2 | RR-8 | RR-9 |
| Light source for | | C | D | E | F | G | A | A |
| exposure/curing step | | | | | | | | |
| Curing process | Light | None | None | None | None | None | None | None |
| through coated | source | | | | | | | |
| surface or rear | Exposure | None | None | None | None | None | None | None |
| surface of | surface | | | | | | | |
| substrate | | | | | | | | |

| | | | | | | | |
|---|---|---|---|---|---|---|---|
| Sensitivity | ◯ | ◯ | X | X | ⊚ | ⊚ | ⊚ |
| Linearity | ◯ | ◯ | ◯ | XX | X | ◯ | ◯ |
| Sectional configuration | ◯ | ◯ | Δ | XX | ◯ | Δ | ◯ |
| Peeling of coated film | ◯ | ◯ | ◯ | Δ | ◯ | ◯ | ◯ |
| Surface wrinkling of | ◯ | ◯ | ◯ | ◯ | ◯ | ◯ | ◯ |
| coated film | | | | | | | |

TABLE 8

| | | Example | Example | Example | Example | Comparative | Comparative | Comparative |
|---|---|---|---|---|---|---|---|---|
| | | 11 | 12 | 13 | 14 | Example 6 | Example 7 | Example 8 |
| Color | | Green | Green | Green | Green | Green | Green | Green |
| Resist | | GR-1 | GR-1 | GR-1 | GR-1 | GR-1 | GR-1 | GR-1 |
| Light source for | | A | B | C | D | E | F | G |
| exposure/curing step | | | | | | | | |
| Curing process | Light | None | None | None | None | None | None | None |
| through coated | source | | | | | | | |
| surface or rear | Exposure | None | None | None | None | None | None | None |
| surface of | surface | | | | | | | |
| substrate | | | | | | | | |

| | | | | | | | |
|---|---|---|---|---|---|---|---|
| Sensitivity | ◯ | ◯ | ◯ | Δ | X | X | ◯ |
| Linearity | ◯ | ◯ | ◯ | ◯ | Δ | X X | ◯ |
| Sectional configuration | ◯ | ◯ | ◯ | ◯ | X | X X | X |
| Peeling of coated film | ◯ | ◯ | ◯ | ◯ | ◯ | Δ | ◯ |
| Surface wrinkling of | ◯ | ◯ | ◯ | ◯ | ◯ | ◯ | ◯ |
| coated film | | | | | | | |

TABLE 9

| | | Example | Example | Example | Example | Example | Example | Example |
|---|---|---|---|---|---|---|---|---|
| | | 15 | 16 | 17 | 18 | 19 | 20 | 21 |
| Color | | Blue | Blue | Blue | Blue | Blue | Blue | Blue |
| Resist | | BR-1 | BR-1 | BR-1 | BR-1 | BR-1 | BR-1 | BR-1 |
| Light source for | | A | B | C | D | A | A | A |
| exposure/curing step | | | | | | | | |
| Curing process | Light | None | None | None | None | G | H | G |
| through coated | source | | | | | | | |
| surface or rear | Exposure | None | None | None | None | Coated | Coated | Rear |
| surface of | surface | | | | | surface | surface | surface |
| substrate | | | | | | | | |

| | | | | | | | |
|---|---|---|---|---|---|---|---|
| Sensitivity | ◯ | ◯ | ◯ | ◯ | ◯ | ◯ | ◯ |
| Linearity | ◯ | ◯ | ◯ | ◯ | ◯ | ◯ | ◯ |
| Sectional configuration | ◯ | ◯ | ◯ | ◯ | ◯ | ◯ | ◯ |
| Peeling of coated film | ◯ | ◯ | ◯ | ◯ | ◯ | ◯ | ◯ |
| Surface wrinkling of | Δ | Δ | Δ | Δ | ◯ | ◯ | ◯ |
| coated film | | | | | | | |

| | | Example | Example | Example | Comparative | Comparative | Comparative |
|---|---|---|---|---|---|---|---|
| | | 22 | 23 | 24 | Example 9 | Example 10 | Example 11 |
| Color | | Blue | Blue | Blue | Blue | Blue | Blue |
| Resist | | BR-1 | BR-2 | BR-3 | BR-1 | BR-1 | BR-1 |
| Light source for | | A | A | A | E | F | G |
| exposure/curing step | | | | | | | |
| Curing process | Light | H | None | None | None | None | None |
| through coated | source | | | | | | |
| surface or rear | Exposure | Rear | None | None | None | None | None |
| surface of | surface | surface | | | | | |
| substrate | | | | | | | |

| | | | | | | |
|---|---|---|---|---|---|---|
| Sensitivity | ◯ | ⊚ | ⊚ | ◯ | X | ⊚ |
| Linearity | ◯ | ◯ | ◯ | X | XX | X |
| Sectional configuration | ◯ | ◯ | ◯ | Δ | XX | Δ |
| Peeling of coated film | ◯ | ◯ | ◯ | ◯ | Δ | ◯ |
| Surface wrinkling of | ◯ | ◯ | ◯ | Δ | ◯ | X |
| coated film | | | | | | |

TABLE 10

| | | Example | Example | Example | Example | Example | Example |
|---|---|---|---|---|---|---|---|
| | | 25 | 26 | 27 | 28 | 29 | 30 |
| Color | | Black | Black | Black | Black | Black | Black |
| Resist | | BMR-1 | BMR-1 | BMR-1 | BMR-1 | BMR-1 | BMR-1 |
| Light source for | | A | B | C | D | A | A |
| exposure/curing step | | | | | | | |
| Curing process | Light | None | None | None | None | G | H |
| through coated | source | | | | | | |
| surface or rear | Exposure | None | None | None | None | Coated | Coated |
| surface of | surface | | | | | surface | surface |
| substrate | | | | | | | |

| | | | | | | |
|---|---|---|---|---|---|---|
| Sensitivity | ◯ | ◯ | ◯ | ◯ | ◯ | ◯ |
| Linearity | ◯ | ◯ | ◯ | ◯ | ◯ | ◯ |
| Sectional configuration | ◯ | ◯ | ◯ | ◯ | ◯ | ◯ |
| Peeling of coated film | ◯ | ◯ | ◯ | ◯ | ◯ | ◯ |
| Surface wrinkling of | Δ | Δ | Δ | Δ | ◯ | ◯ |
| coated film | | | | | | |
| Adhesion to substrate | Δ | Δ | Δ | Δ | ◯ | ◯ |

| | | Example | Example | Comparative | Comparative | Comparative |
|---|---|---|---|---|---|---|
| | | 31 | 32 | Example 12 | Example 13 | Example 14 |
| Color | | Black | Black | Black | Black | Black |
| Resist | | BMR-1 | BMR-1 | BMR-1 | BMR-1 | BMR-1 |
| Light source for | | A | A | E | F | G |
| exposure/curing step | | | | | | |
| Curing process | Light | G | H | None | None | None |
| through coated | source | | | | | |
| surface or rear | Exposure | Rear | Rear | None | None | None |
| surface of | surface | surface | surface | | | |
| substrate | | | | | | |

| | | | | | |
|---|---|---|---|---|---|
| Sensitivity | ◯ | ◯ | ◯ | X | ◯ |
| Linearity | ◯ | ◯ | X | XX | X |
| Sectional configuration | ◯ | ◯ | X | XX | X |
| Peeling of coated film | ◯ | ◯ | ◯ | Δ | ◯ |
| Surface wrinkling of | ◯ | ◯ | Δ | Δ | X |
| coated film | | | | | |
| Adhesion to substrate | ◯ | ◯ | Δ | Δ | Δ |

As shown in above Tables 7-10, even though there are slight differences according to the recipe, the coloring compositions of Examples 1-32 were found to be useful in terms of all of the sensitivity, the pattern configuration (linearity and sectional configuration), the peeling of coated film and the surface wrinkling of coated film. Further, with respect to the adhesion of the black matrix to the substrate, the black matrixes which were subjected to a curing process after the development were found more excellent as compared with those which were not subjected to a curing process after the development. On the other hand, in the cases of the coloring compositions of Comparative Examples 1 and 2, since the ratio (M/P) of the weight (M) of the monomer having an ethylenic unsaturated double bond to the weight (P) of the transparent resin was out of the range of 0.12-1.35, these coloring compositions were found inferior in all of the sensitivity, the pattern configuration (linearity and sectional configuration), the peeling of coated film and the surface wrinkling of coated film, thereby making it impossible to obtain filter segments and a black matrix excellent in all of these features. Further, in the cases of the coloring compositions of Comparative Examples 3-14, since a laser beam having a wavelength of 340-380 nm was not employed as a light source and, instead, an excimer laser having an operating wavelength of 308 nm, a semiconductor laser having an operating wavelength of 405 nm or an ultra-high pressure mercury lamp was employed as a light source, these coloring compositions were found inferior in all of the sensitivity, the pattern configuration (linearity and sectional configuration), the peeling of coated film and the surface wrinkling of coated film, thereby making it impossible to obtain filter segments and black matrix excellent in all of these features.

Additional advantages and modifications will readily occur to those skilled in the art. Therefore, the invention in its broader embodiments is not limited to the specific details and representative embodiments shown and described herein. Accordingly, various modifications may be made without departing from the spirit or scope of the general inventive concept as defined by the appended claims and their equivalents.

What is claimed is:

1. A coloring composition comprising:
a pigment;
a transparent resin;
a monomer having an ethylenic unsaturated double bond;
and a photo-polymerization initiator,
wherein a ratio (M/P) of weight (M) of the monomer having an ethylenic unsaturated double bond to weight (P) of the transparent resin is confined to a range of 0.12 to 1.35, and the coloring composition is adapted to be employed in a manufacturing method of a color filter including: coating a surface of a substrate with the coloring composition; irradiating a filter segment-forming region or a black matrix-forming region of the coated coloring composition film with a laser beam having a wavelength of 340 nm to 380 nm, thereby curing the irradiated region; and removing uncured portion of the coated coloring composition film to form the filter segment or the black matrix.

2. The coloring composition according to claim 1, wherein a laser source is a solid YAG laser exhibiting an operating wavelength of 343 nm, an XeG excimer laser exhibiting an operating wavelength of 351 nm or a semiconductor laser exhibiting an operating wavelength of 375 nm.

3. The coloring composition according to claim 1, wherein a ratio (I/M) of weight (I) of the photo-polymerization initiator to weight (M) of the monomer having an ethylenic unsaturated double bond is confined to a range of 0.20 to 1.00.

4. The coloring composition according to claim 1, which further comprises a polymerization inhibitor.

5. The coloring composition according to claim 4, wherein the polymerization inhibitor is 1,4-hydroquinone and/or alkyl hydroquinone-based compounds.

6. The coloring composition according to claim 1, wherein the pigment is a blue pigment and the photo-polymerization initiator is an oxime ester-based photo-polymerization initiator, the coloring composition further comprising a polyfunctional thiol.

7. The coloring composition according to claim 6, wherein the oxime ester-based photo-polymerization initiator is a compound represented by the following general formula (1) or (2); 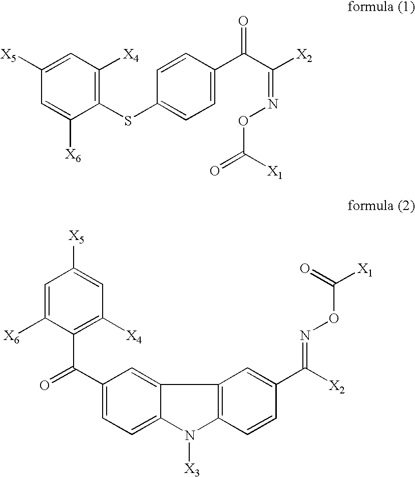
wherein, X₁-X₆ represent respectively a hydrogen atom, a cyclic, linear or branched alkyl group having 1-12 carbon atoms or a phenyl group, and each of the alkyl group and phenyl group may be replaced by a substituent group selected from a halogen atom, alkoxyl group having 1-6 carbon atoms and phenyl group.

8. The coloring composition according to claim 1, wherein the monomer having an ethylenic unsaturated double bond is a polyfunctional monomer having at least six ethylenic unsaturated double bonds.

9. A method of manufacturing a color filter, which comprises:
coating a substrate with the coloring composition recited in claim 1 to form a color coated film;
irradiating a filter segment-forming region or a black matrix-forming region of the color coated film with a laser beam having a wavelength of 340-380 nm, thereby curing the irradiated region; and
removing uncured portions of the color coated film to form the filter segment or the black matrix.

10. The method of manufacturing a color filter according to claim 9, wherein forming the filter segment or the black matrix further comprises irradiating the color coated film side or a rear surface side of the substrate with an active energy beam after removing uncured portions of the color coated film.

11. The method of manufacturing a color filter according to claim 9, wherein an energy density of the laser beam per pulse is confined to 0.1 mJ/cm²-10000 mJ/cm², and a pulse width of the laser beam is confined to 0.1 nsec-30000 nsec.

12. The method of manufacturing a color filter according to claim 9, wherein a frequency of the laser beam is confined to 1 Hz-50000 Hz.

13. A color filter comprising a black matrix and/or filter segments exhibiting at least one color, which are formed through the method according to claim 9.
